(19) United States
(12) Patent Application Publication
(10) Pub. No.: US 2018/0306978 A1
(43) Pub. Date: Oct. 25, 2018

(54) OPTICAL MULTIPLEXER AND IMAGE PROJECTION APPARATUS EQUIPPED WITH OPTICAL MULTIPLEXER

(71) Applicant: SHARP KABUSHIKI KAISHA, Sakai City, Osaka (JP)

(72) Inventors: TOSHIO KAGAWA, Sakai City (JP); MASATAKA ANDOU, Sakai City (JP); PETER JOHN ROBERTS, Sakai City (JP); VALERIE BERRYMAN-BOUSQUET, Sakai City (JP)

(73) Assignee: SHARP KABUSHIKI KAISHA, Sakai City, Osaka (JP)

(21) Appl. No.: 15/768,146

(22) PCT Filed: Oct. 13, 2016
(86) PCT No.: PCT/JP2016/080403

§ 371 Date: Apr. 13, 2018

(30) Foreign Application Priority Data
Oct. 14, 2015 (JP) 2015-203233

(51) Int. Cl. G02B 6/293; H04N 9/31; H04N 1/00

(52) U.S. Cl. CPC G02B 6/29388; H04N 9/3135; G02B 26/101; H04N 1/00267; H04N 9/3182

(57) ABSTRACT

An optical multiplexer (10) that multiplexes a plurality of light beams having different wavelengths includes a first waveguide (101) that receives first-wavelength light, a second waveguide (102) that receives second-wavelength light having a shorter wavelength than the first-wavelength light, a third waveguide (103) that receives third-wavelength light having a shorter wavelength than the second-wavelength light, a first multiplexer (110) in which the light propagates between the first waveguide (101) and the second waveguide (102), and a second multiplexer (120) in which the light propagates between the first waveguide (101) and the third waveguide (103). The second-wavelength light is propagated to the first waveguide (101) at the first multiplexer (110). The third-wavelength light is propagated to the first waveguide (101) at the second multiplexer (120).

### TECHNICAL FIELD

The present invention relates to optical multiplexers that multiplex three visible light beams having different wavelengths, and to image projection apparatuses equipped with such optical multiplexers.

### BACKGROUND ART

A known display device in the related art may project an image onto a screen by two-dimensionally scanning, laser light thereon. In this display device, individual light beams having R (red), G (green), and B (blue) wavelengths, which correspond to the three primary colors, form a multiplexed light source along a single optical axis to be used as the light beams of the display device. The visible light of the three multiplexed colors is transmitted to an image display unit. The image display unit projects an image by two-dimensionally scanning the transmitted light. For example, Cited Reference 1 discloses a technology in which a dichroic mirror multiplexes the light beams.

However, in the display device of this type, the use of the dichroic mirror makes it difficult to achieve further size reduction of the light source. Therefore, in a case where the display device is a wearable device that is to be worn on the head of a user, such as an eyewear, an increase in size of the light source causes the device to be large in size, thus making it necessary to fix the light source to a different location (such as the user's arm or waist).

There is a known optical coupling device that uses directional couplers (e.g., see Patent Literature 2). By using such an optical coupling device, size reduction of the display can be expected.

For example, in a technology disclosed in Patent Literature 2, three different wavelengths are input to optical waveguides, and visible light beams are multiplexed by using three multiplexers.

### CITATION LIST

### Patent Literature

PTL 1: Japanese Unexamined Patent application Publication No. 2007-93945

PTL 2: Japanese Unexamined Patent Application Publication No. 2013-195603

### SUMMARY OF INVENTION

### Technical Problem

Although visible light beams of three wavelengths can be multiplexed in the technology that uses directional couplers disclosed in Patent Literature 2, the multiplexers require extremely high processing accuracy. Moreover, the wavelength to be input to the middle waveguide is limited, which is problematic in that, when creating a waveguide pattern, it is difficult to achieve further size reduction in view of loss caused by, for example, light absorption.

The present invention has been made to solve these problems, and an object thereof is to provide an optical multiplexer that can be further reduced in size and an image projection apparatus equipped with such an optical multiplexer.

### Solution to Problem

In order to solve the aforementioned problems, an optical multiplexer according to the present invention multiplexes a plurality of light beams having different wavelengths and includes a first waveguide that receives first-wavelength light, a second waveguide that receives second-wavelength light having a shorter wavelength than the first-wavelength light, a third waveguide that receives third-wavelength light having a shorter wavelength than the second-wavelength light, a first multiplexer in which the light propagates between the first waveguide and the second waveguide, and a second multiplexer in which the light propagates between the third waveguide and the first waveguide. The second-wavelength light is propagated to the first waveguide at the first multiplexer. The third-wavelength light is propagated to the first waveguide at the second multiplexer.

Furthermore, in the optical multiplexer according to the present invention, the first multiplexer may have a length that is substantially half a length of the second multiplexer in the propagation direction.

Furthermore, in the optical multiplexer according to the present invention, the length of the first multiplexer may be equal to twice a mode coupling length of the first-wavelength light.

Furthermore, in the optical multiplexer according to the present invention, the first waveguide, the second waveguide, and the third waveguide may be formed of a core layer and have a cladding layer disposed around the core layer and having a smaller refractive index than the core layer.

Furthermore, in the optical multiplexer according to the present invention, it is preferable that the plurality of light beams having the different wavelengths be visible light beams.

Furthermore, in the optical multiplexer according to the present invention, the first-wavelength light may be propagated to the second waveguide in accordance with mode coupling at the first multiplexer, the first-wavelength light propagated to the second waveguide may be propagated again to the first waveguide at the first multiplexer, the first-wavelength light propagated again to the first waveguide may be propagated to the third waveguide at the second multiplexer, and the first-wavelength light propagated to the third waveguide may be propagated again to the first waveguide at the second multiplexer.

Furthermore, in the optical multiplexer according to the present invention, the second-wavelength light may be propagated to the first waveguide in accordance with mode coupling at the first multiplexer, and the second-wavelength light propagated to the first waveguide may be propagated to the third waveguide at the second multiplexer and may be subsequently propagated again to the first waveguide.

Furthermore, in the optical multiplexer according to the present invention, the third-wavelength light may be propagated to the first waveguide in accordance with mode coupling at the second multiplexer.

An image projection apparatus according to the present invention is equipped with the optical multiplexer having the above-described configuration and includes a first light source that outputs the first-wavelength light to the first waveguide, a second light source that outputs the second-wavelength light to the second waveguide, a third light source that outputs the third-wavelength light to the third waveguide, and an image forming unit that two-dimensionally scans wavelength-multiplexed light output from the optical multiplexer so as to project an image onto a projection surface.

### Advantageous Effects of Invention

With the optical multiplexer according to the present invention, a single mode can be obtained with an extremely high output rate for each of light beams of wavelengths to be multiplexed even if there are individual differences occurring from the manufacturing process. Consequently, an optical multiplexer that is smaller in size than the aforementioned optical multiplexer in the related art can be realized while maintaining high performance.

### BRIEF DESCRIPTION OF DRAWINGS

FIG. 1A is a plan view schematically illustrating the configuration of an optical multiplexer according to a first embodiment of the present invention.

FIG. 1B is a side view of the optical multiplexer shown in FIG. 1A, as viewed from the left.

FIG. 2A illustrates the operation of the optical multiplexer according to the first embodiment, and shows a light propagation state in a case where a single-mode red light beam (R) is input.

FIG. 2B illustrates the operation of the optical multiplexer according to the first embodiment, and shows a light propagation state in a case where a single-mode green light beam (G) is input.

FIG. 2C illustrates the operation of the optical multiplexer according to the first embodiment, and shows a light propagation state in a case where a single-mode blue light beam (B) is input.

FIG. 3 illustrates sections where individual differences occur in the optical multiplexer according to the first embodiment.

FIG. 4A is a graph illustrating the relationship between an output and a variation of gap width in the optical multiplexer according to the first embodiment.

FIG. 4B is a graph illustrating the relationship between an output and a variation of gap width in the optical multiplexer according to the first embodiment.

FIG. 5A is a graph illustrating the relationship between an output and a variation of core width in the optical multiplexer according to the first embodiment.

FIG. 5B is a graph illustrating the relationship between an output and a variation of core width in the optical multiplexer according to the first embodiment.

FIG. 5C is a graph illustrating the relationship between an output and a variation of core width in the optical multiplexer according to the first embodiment.

FIG. 6A is a graph illustrating the relationship between an output and a variation of coupling length in the optical multiplexer according to the first embodiment.

FIG. 6B is a graph illustrating the relationship between an output and a variation of coupling length in the optical multiplexer according to the first embodiment.

FIG. 7 is a graph illustrating the relationship between an output and a variation of wavelength in the optical multiplexer according to the first embodiment.

FIG. 8 is a schematic configuration diagram in a case where the optical multiplexer according to the present invention is applied to a scan-type display serving as an example of an image projection apparatus.

### DESCRIPTION OF EMBODIMENTS

Embodiments of the present invention will be described below with reference to the drawings.

### First Embodiment

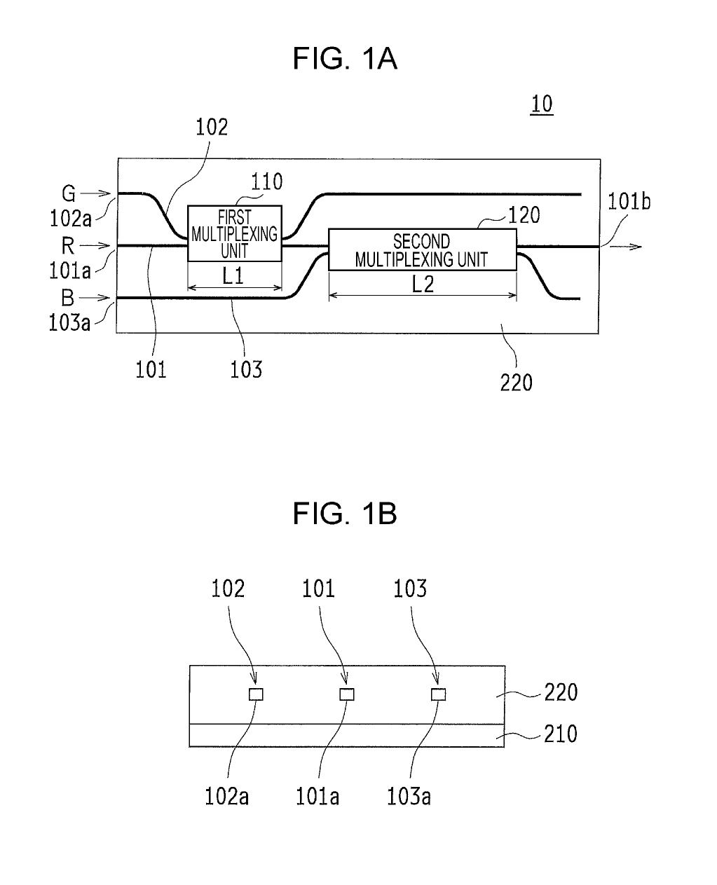

FIG. 1A is a plan view schematically illustrating the configuration of an optical multiplexer according to a first embodiment of the present invention. FIG. 1B is a side view of the optical multiplexer shown in FIG. 1A, as viewed from the left.

Three visible light beams to be multiplexed in the optical multiplexer according to the first embodiment are single-color light beams, and conditions are such that the first visible light beam has the longest wavelength, the second visible light beam has the second longest wavelength, and the third visible light beam has the shortest wavelength.

The following description relates to an example in which the three visible light beams having the different wavelengths are a red light beam (R), a green light beam (G), and a blue light beam (B), respectively.

Normally, a red light beam has a wavelength λR. ranging between 620 nm and 750 nm, a green light beam has a wavelength λG ranging between 495 nm and 570 nm, and a blue light beam has a wavelength λB ranging between 450 nm and 495 nm, and the three wavelengths of the RGB light beams have the relationship λB<λG<λR. For example, a light beam with a wavelength λR of 638 nm is selected as the red light beam, a light beam with a wavelength λG of 520 nm is selected as the green light beam, and a light beam with a wavelength λB of 450 nm is selected as the blue light beam.

An optical multiplexer 10 includes a substrate 210, a cladding layer 220 formed on the substrate 210, and a first waveguide 101, a second waveguide 102, and a third waveguide 103 that are formed in the cladding layer 220 and that are disposed in a plane parallel to the substrate 210.

The first waveguide 101, the second waveguide 102, and the third waveguide 103 receive single-mode red (R), green (C), and blue (B) light beams having different wavelengths via first ends 101a, 102a, and 103a exposed on one surface of the cladding layer 220. The R, G, and B light beams are multiplexed while being propagated through the first waveguide 101, the second waveguide 102, and the third waveguide 103, respectively, and the multiplexed light is output from a second end 101b of the first waveguide 101 exposed on the other surface of the cladding layer 220. In this case, since the red light beam (R) has the longest wavelength and has the largest loss from bending of the waveguide, it is desirable that the red light beam be input to the non-bending first waveguide located in the middle.

A visible-light propagation path of the first waveguide 101 is provided with a first multiplexer 110 and a second multiplexer 120 in that order from the first end 101a. The first waveguide 101, the second waveguide 102, and the third waveguide 103 are disposed with distances therebetween that prevent optical coupling from occurring in regions other than the first multiplexer 110 and the second multiplexer 120.

The first multiplexer 110 and the second multiplexer 120 are constituted of directional couplers. In the first multiplexer 110, the second waveguide 102 is in contact with the first waveguide 101 with a gap width, which will be described later, and in the second. multiplexer 120, the third waveguide 103 is in contact with the first waveguide 101 with a gap width, which will be described later. Accordingly, the R, G, and B light beams are multiplexed.

In the first embodiment, the first multiplexer 110 has a length L1 that is equal to twice the mode coupling length of the wavelength of the first visible light beam (i.e., the length of a coupling section where 100% of light input to one of waveguides in a directional coupler is output from the other waveguide) and that is substantially half a length L2 of the second multiplexer.

As specific dimensions of the lengths L1 and L2 in a case where the three visible fight, beams are R, G, and B light beams, for example, the length L1 is equal to about 1400 μm and the length L2 is equal to about 2800 μm.

In the first multiplexer 110, the green light beam in the second waveguide 102 is propagated to the first waveguide 101 in accordance with mode coupling. In the first multiplexer 110, it is preferable that the green light beam in the second waveguide 102 be substantially entirely propagated to the first waveguide 101.

In the second multiplexer 120, the blue light beam in the third waveguide 103 is propagated to the first waveguide 101 in accordance with mode coupling. In the second multiplexer 120, it is preferable that the blue light beam in the third waveguide 103 be substantially entirely propagated to the first waveguide 101.

The optical multiplexer 10 having the above-described configuration can be formed by a known method, such as a flame hydrolysis deposition method or a sputtering method. For example, a low-refractive-index silicon oxide film, which is to serve as the cladding layer 220, is formed on the substrate 210 composed of silicon by a flame hydrolysis deposition method, and a high-refractive-index silicon oxide film, which is to serve as a core layer, is subsequently stacked thereon. Then, by using a photomask having a pattern according to the shapes of the first to third waveguides 101, 102, and 103, the core layer is patterned as an optical waveguide having a fixed core width by photolithography.

Subsequently, a low-refractive-index silicon oxide film, which is to serve as the cladding layer 220, is stacked on this core layer so as to cover the optical waveguide core. For example, by using a layer having an absolute refractive index of about 1.46 as the cladding layer, the core layer would have a refractive-index difference of about 0.5%, so that the light propagating through the core repeatedly undergoes internal reflection, whereby the light can be efficiently propagated through the core. If the core diameter in this case is about 2 μm, the R, G, and B light beams can be propagated in a single mode. It is desirable that the cladding layer have a thickness of 10 μm or larger for achieving efficient light propagation.

Finally, by grinding both end surfaces of the substrate 210 and the cladding lever 220, the first ends 101a, 102a, and 103a of the first to third waveguides 101, 102, and 103 and the second end 101b of the second waveguide 102 become exposed, whereby the optical multiplexer 10 is completed.

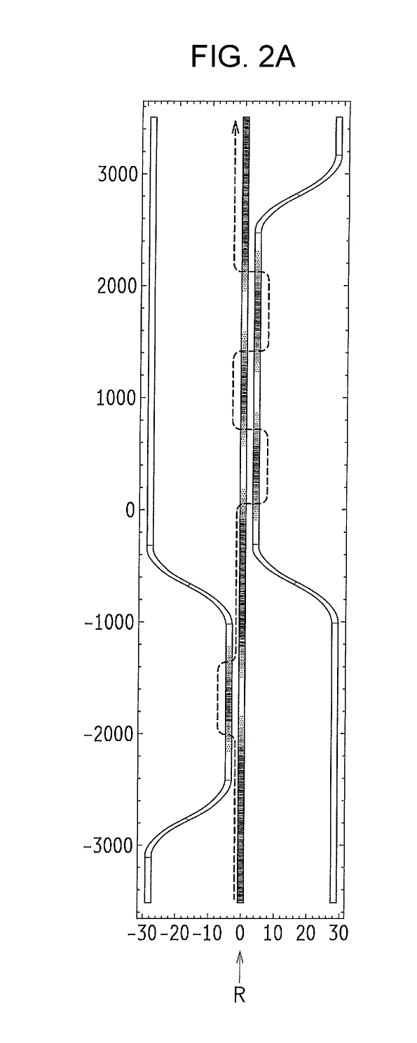

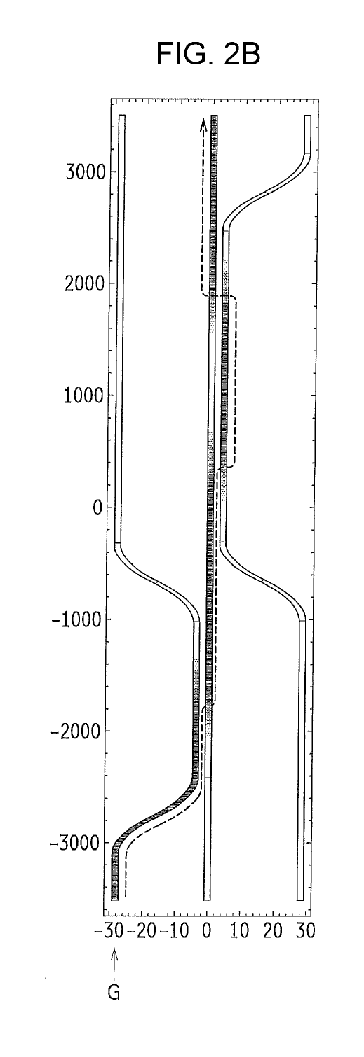

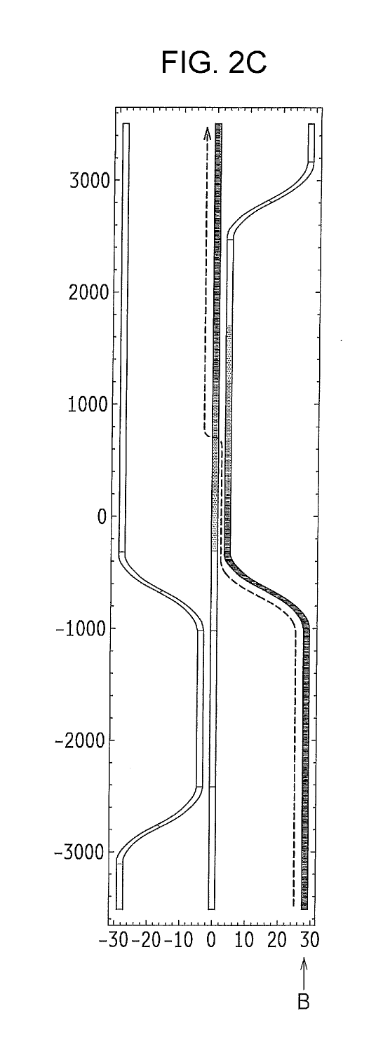

Next, the operation and advantages of the optical multiplexer 10 having the above-described configuration will be described with reference to FIGS. 2A to 2C.

FIGS. 2A to 2C illustrate results obtained using the first to third waveguides 101, 102, and 103 constituted of a cladding layer 220 having an absolute refractive index of 1.46 and a core layer having a diameter of 2 μm and a refractive-index difference of 0.5% relative to the cladding layer 220. FIG. 2A corresponds to a case where a single-mode red light beam (R) is input, FIG. 2B corresponds to a case where a single-mode green light beam (G) is input, and FIG. 2C corresponds to a case where a single-mode blue light beam (B) is input. FIGS. 2A to 2C illustrate how the R, G, and B light beams are propagated through the waveguides 101, 102, and 103 via the first multiplexer 110 and the second multiplexer 120. In order to perform beam shaping efficiently with, for example, a lens, it is ideal that single-mode light beams be used as the light beams.

In FIGS. 2A to 2C, the intensity of light propagating through the optical multiplexer 10 is expressed in gradations, such that more highlighted areas (i.e., black areas in the drawings) indicate that the intensity of light is stronger.

As shown in FIG. 2A, the output of the red light beam (R) input to the first waveguide 101 is substantially entirely propagated to the second waveguide 102 in accordance with mode coupling at the first multiplexer 110. Then, the red light beam (R) propagated to the second waveguide 102 is propagated again to the first waveguide in accordance with mode coupling at the first multiplexer 110. By giving the first multiplexer 110 a length that is twice the mode coupling length of the wavelength of the first visible light beam, substantially 100% of the light beam traveling from the first waveguide 101 can be returned again to the first waveguide 101 via the second waveguide 102. Subsequently, at the second multiplexer 120, the output of the red light beam (R) is substantially entirely propagated to the third waveguide 103 similarly in accordance with mode coupling, and is then propagated again to the first waveguide 101. Because giving the second multiplexer 120 a length that is twice the length of the first multiplexer 110 would make the length of the second multiplexer 120 four times the mode coupling length of the wavelength of the first visible light beam, substantially 100% of the light beam traveling from the first waveguide 101 can be returned again to the first waveguide 101 via the third waveguide 103. In FIG. 2A, the propagation path of the input red light beam (R) is indicated by a dashed arrow.

As shown in FIG. 2B, the output of the green light beam (G) input to the second waveguide 102 is substantially entirely propagated to the first waveguide 101 in accordance with mode coupling at the first multiplexer 110. Then, the green light beam (G) propagated to the first waveguide 101 is propagated to the third waveguide 103 in accordance with mode coupling at the second multiplexer 120, and is ultimately propagated to the first waveguide 101 in accordance with mode coupling again. In FIG. 2B, the propagation path of the input green light beam (G) is indicated by a dashed arrow.

As shown in FIG. 2C, the out of the blue light beam (B) input to the third waveguide 103 is substantially entirely propagated to the first waveguide 101 in accordance with mode coupling at the second multiplexer 120. In FIG. 2C, the propagation path of the input blue light beam (B) is indicated by a dashed arrow.

Accordingly, by inputting the single-mode R, G, and B light beams simultaneously to the three waveguides 101, 102, and 103, multiplexed light obtained as a result. of multiplexing the R, G, and B light beams is output from a second end 102b of the second waveguide 102 as color light according to the intensities of the color light beams.

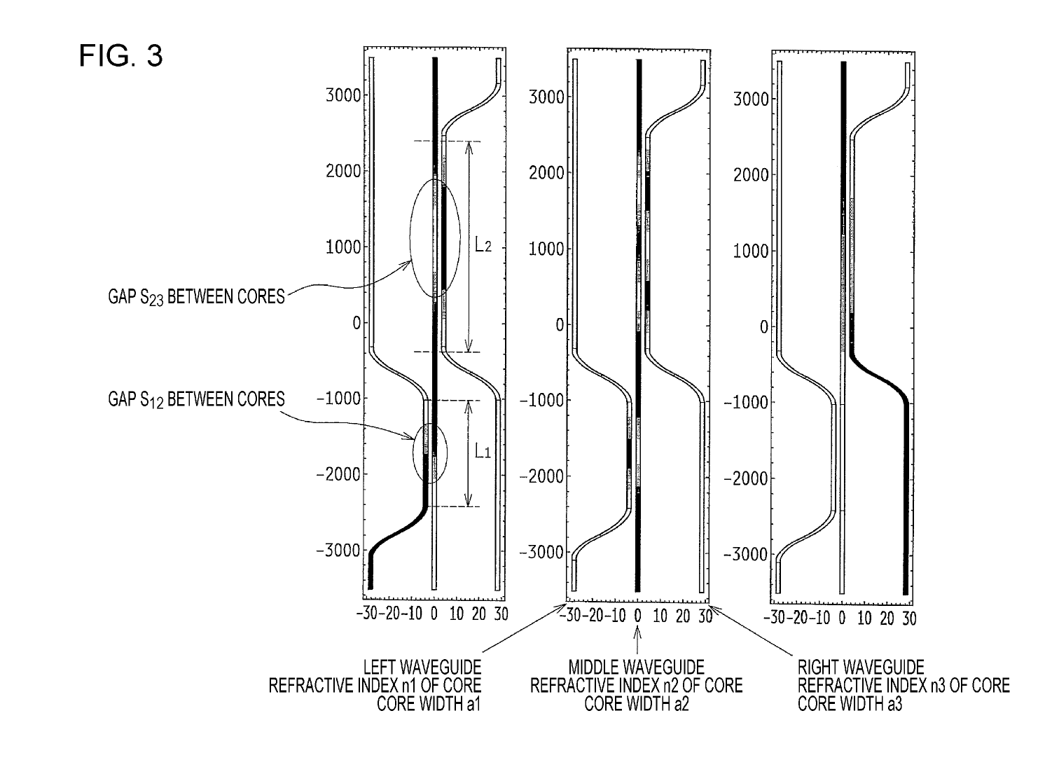

Optical waveguides have individual differences occurring from the manufacturing process thereof. Individual differences are manufacturing variations occurring in dimensional sections of directional couplers that form multiplexers, and affect the performance. Examples include a gap width between waveguides, the width of a core of a waveguide, and the length of a coupling section. Furthermore, there are individual differences occurring during the manufacturing process of light sources, such as LEDs and LDs. Such individual differences cause the wavelength of output light to vary. The following description with reference to FIGS. 3 to 7 relates to how an output from the optical multiplexer 10 changes relative to such variations.

FIG. 3 illustrates the names of sections for explaining the above-described individual differences of optical multiplexers. In this drawing, three identical optical multiplexers (i.e., the three optical multiplexers shown in FIGS. 2A to 2C in that order) are disposed side-by-side for promoting a better understanding. For example, with reference to a drawing of the middle optical multiplexer, the refractive indices of the cores through which the light beams of the respective colors are guided are defined as n1, n2, and n3 from the left, and the core widths are defined as a1, a2, and a3. With reference to a drawing of the optical multiplexer at the far left, the length along which the left waveguide and the middle waveguide are coupled is defined as L1, and the length along which the right waveguide and the middle waveguide are coupled is defined as L2.

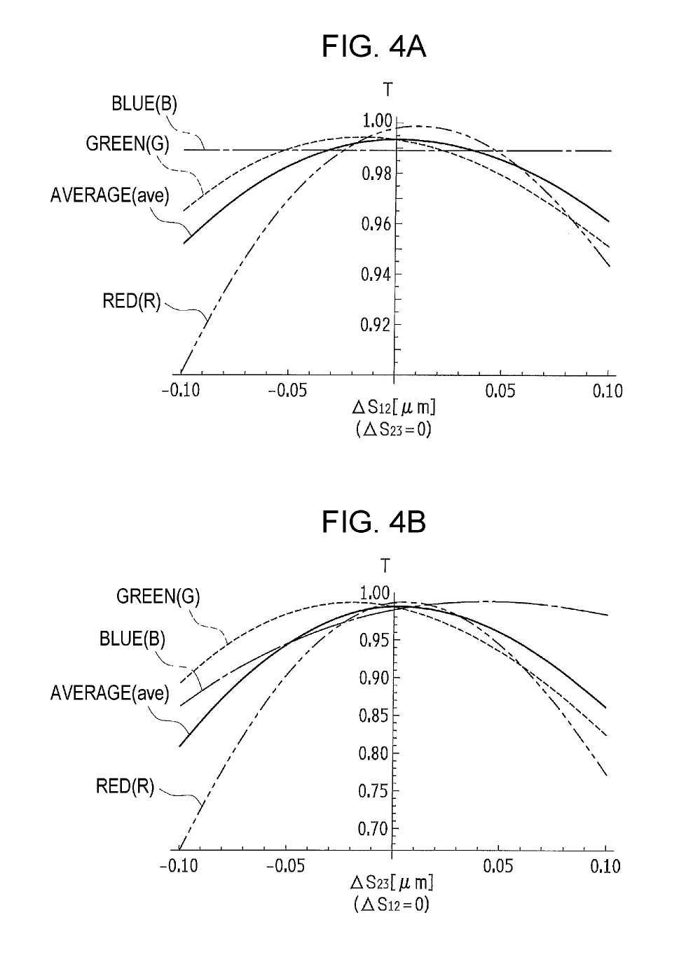

The abscissa axis in each of FIGS. 4A and 4B indicates a deviation ΔS from a reference gap width. Specifically, ΔS₁₂ is a deviation from a design value of the gap between the cores of the first waveguide 101 and the second waveguide 102 in the first multiplexer 110, and ΔS₂₃ is a deviation from a design value of the gap between the cores of the first waveguide 101 and the third waveguide 103 in the second multiplexer 120. A reference gap width a is 2 μm. The ordinate axis in each of FIGS. 4A and 4B indicates a proportion T of the intensity of output light to the intensity of light input to the optical multiplexer 10. As shown in FIGS. 4A and 4B, with the reference gap width, a single mode can be obtained with an output of 98% or higher for each of the red light beam (R), the green light beam (G), and the blue light beam (B). If the deviation is about ±0.08 μm from the reference gap, a single mode can be obtained constantly with an output of 80% or higher at each wavelength.

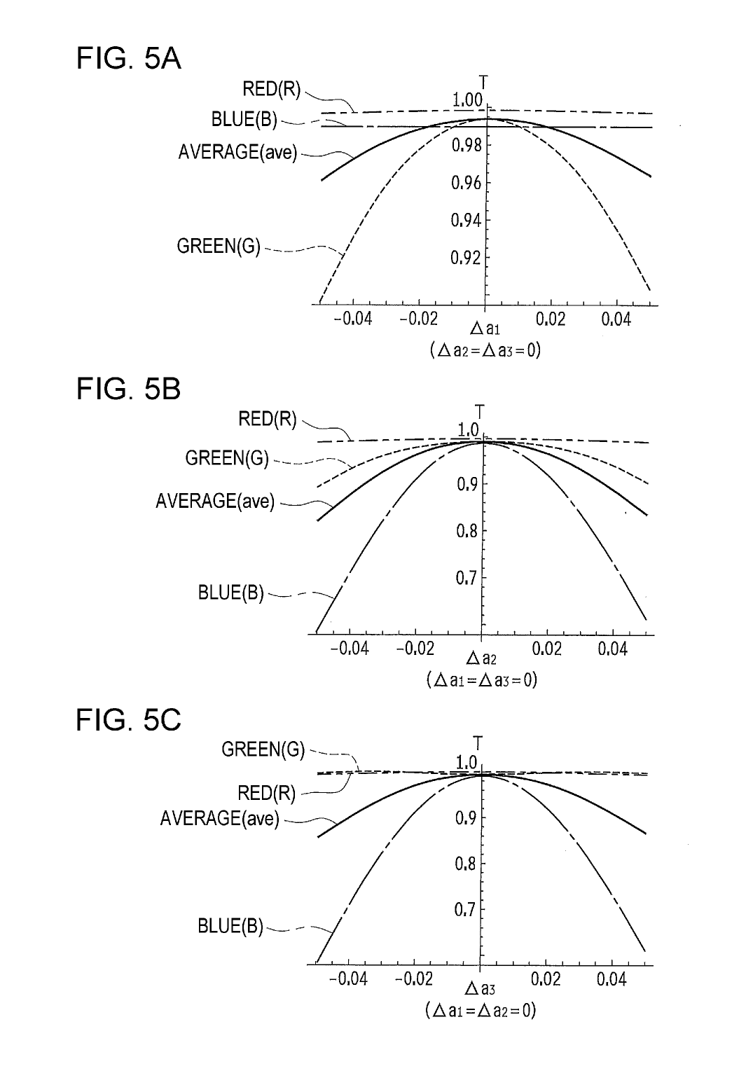

The abscissa axis in each of FIGS. 5A to 5C indicates a deviation Δa from a reference core width. Specifically, Δa₁ is a deviation from a core width a1 of the first waveguide 101, Δa₂ is a deviation from a core width a2 of the second waveguide 102, and Δa₃ is a deviation from a core width a3 of the third waveguide 103. The reference core width is 2 μm. The ordinate axis in each of FIGS. 5A to 5C indicates a proportion T of the intensity of output light to the intensity of light input to the optical multiplexer 10. As shown in FIGS. 5A to 5C, with the reference core width, a single mode can be obtained with an output of 98% or higher for each of the red light beam (R), the green light beam (G), and the blue light beam (B). If the deviation is about ±0.03 μm from the reference core width, a single mode can be obtained constantly with an output of 80% or higher at each wavelength.

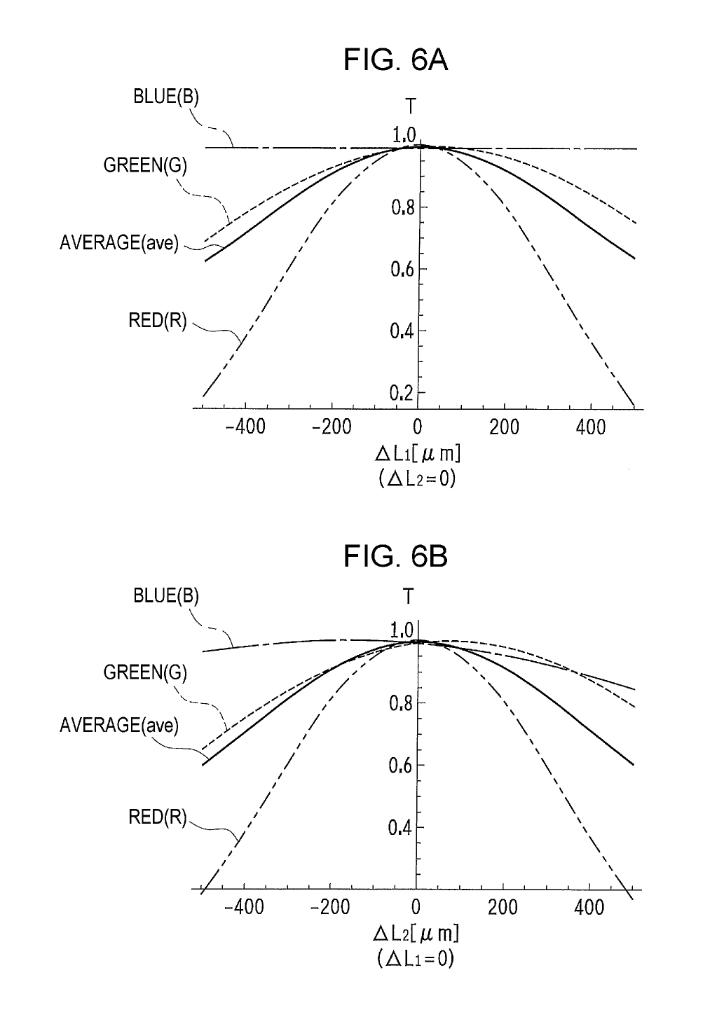

The abscissa axis in each of FIGS. 6A and 6B indicates a deviation ΔL from a reference coupling length Specifically, ΔL₁ is a deviation from a design value L1 of the first multiplexer 110, and ΔL₂ is a deviation from a design value L2 of the second multiplexer 120. The reference coupling length depends on the wavelength to be used and the core diameter, and is set such that, for example, L1=1.4 mm and L2=2.8 mm in the first embodiment. The ordinate axis in each of FIGS. 6A and 6B indicates a proportion T of the intensity of output light to the intensity of light input to the optical multiplexer 10. As shown in FIGS. 6A. and 6B, with the reference coupling length, a single mode can be obtained with an output of 98% or higher for each of the red light beam (R), the green light beam (G), and the blue light beam (B). If the deviation is about ±200 μm from the reference coupling length, a single mode can be obtained constantly with an output of 80% or higher at each wavelength.

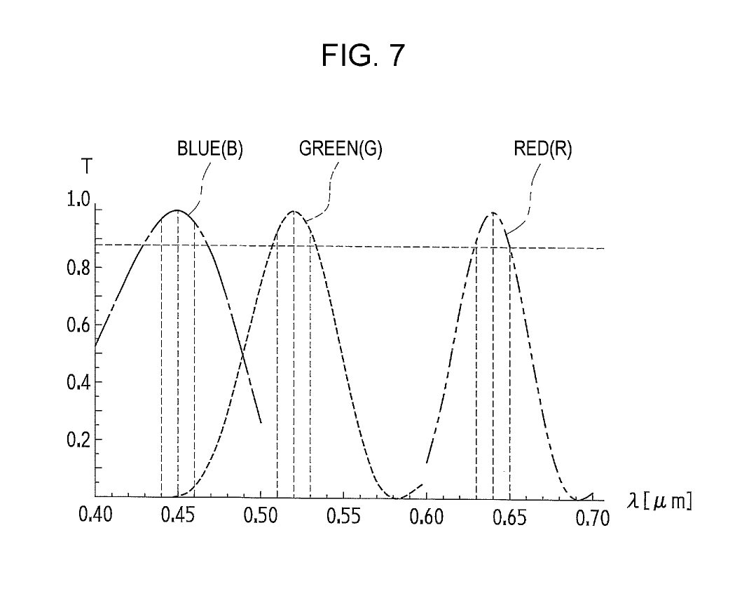

In FIG. 7, the abscissa axis indicates a deviation from a reference wavelength, and the ordinate axis indicates a proportion T of the intensity of output light to the intensity of light input to the optical multiplexer 10. The reference wavelength is set such that the wavelength λR is equal to 638 nm for the red light beam (R), the wavelength λG is equal to 520 nm for the green light beam (G), and the wavelength λB is equal to 450 nm for the blue light beam (B). As shown in FIG. 7, if the deviation is about ±10 μm from the reference wavelength, a single mode can be obtained constantly with an output of 88% or higher at each wavelength.

Accordingly in the optical multiplexer 10 according to the first embodiment, a single mode can be obtained with an extremely high output rate for each of light beams of wavelengths to be multiplexed even if there are individual differences occurring from the manufacturing process. Consequently, an optical multiplexer that is smaller in size than the aforementioned optical multiplexer in the related art can be realized while maintaining high performance.

### Configuration of Scan-Type Display

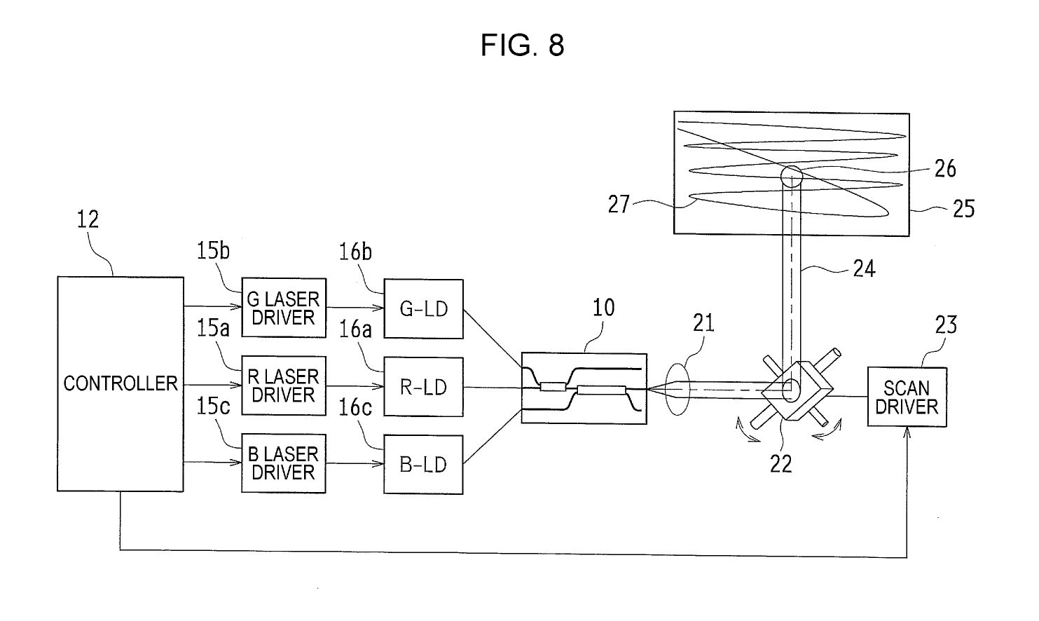

FIG. 8 is a schematic configuration diagram in a case where the optical multiplexer 10 having the above-described configuration is applied to a scan-type display serving as an example of an image projection apparatus.

This scan-type display is roughly constituted of, for example, a controller 12, R, G, and B laser drivers 15a to 15c, LDs 16a to 16c corresponding to R, G, and B, the optical multiplexer 10, a lens 21, a scanner 22, a scan driver 23, a relay optical system 24, and a screen 25. In FIG. 8, a detailed configuration of the relay optical system 24 is omitted.

The controller 12 controls the laser output of each wavelength, and the electric current according to the result thereof is applied from the R laser driver 15a, the G laser driver 15b, the B laser driver 15c to the R-LD 1 6a, the G-LD 16b, and the B-LD 16c, respectively. Then, the output light travels through the optical multiplexer 10, is adjusted to desired light, and subsequently travels through the lens 21, so as to be beam-shaped. The beam shape varies depending on the performance of the scanner 22 to be used, as well as the specifications of the display.

The light beam-shaped by the lens 21 is reflected at the scanner 22 and is projected onto the screen 25, so as to be focused as projection light 26 onto a bright point on the screen 25. The controller 12 controls the scanner 22 by transmitting a horizontal signal and a vertical signal to the scan driver 23. These signals include a synchronization signal for setting the timing for operating the scanner 22 and a drive setting signal for setting the voltage and frequency of a drive signal.

The laser drivers 15a to 15c perform modulation-driving on the lasers 16a to 16c so that laser beams with intensities according to the signals of the respective wavelengths from the controller 12 are generated. By adjusting the output ratio of the laser beams of the respective colors, laser beams with desired reproduced colors are output.

The scanner 22 is horizontally-scanned and vertically-scanned in synchronization with the modulation-driving of the lasers 16a to 16c, so that the projection light 26 is scanned to form a trajectory 27 on the screen 25, whereby a two-dimensional image is rendered on the screen 25.

Although a preferred embodiment of the present invention has been described, the present invention is not limited to the above-described configuration.

For example, although R, G, and B light beams are described as an example of three visible light beams with different wavelengths in the above-described configuration, three visible light beams other than R, G, and B light beams can be multiplexed in the present invention so long as the light beams have fixed wavelengths (single-color light beams) and satisfy the wavelength conditions described above.

### Second Embodiment

Although the waveguides 101, 102, and 103 are formed in a plane parallel to the surface of the substrate 210 in the first embodiment described above, the substrate is not necessarily a required component. Moreover, the arrangement of the waveguides 101, 102, and 103 is not limited to the two-dimensional arrangement described above and may be, for example, three-dimensional configuration, such as arranging the waveguides 102 and 103 alone a circle centered on the waveguide 101.

### Third Embodiment

Although the waveguides 101, 102, and 103 are integrally formed by embedding a core layer within the cladding layer 220 in the first embodiment described above, waveguides 101, 102, and 103 formed of a core layer and a cladding layer may be formed separately and be disposed on a supporter, such as a substrate.

The embodiments disclosed herein are exemplary in all aspects and are not to serve as grounds for limited interpretations. Therefore, the technical scope of the present invention is not to be interpreted by the above-described. embodiments alone and is to be defined based on the scope of the claims. Furthermore, meanings equivalent to the scope of the claims and all modifications within the scope are included.

The present application claims priority to Japanese Patent Application No. 2015-203233 filed Oct. 14, 2015. The contents of these applications are incorporated herein by reference in their entirety.

### INDUSTRIAL APPLICABILITY

According to the present invention, in the technical field of optical multiplexers that multiplex visible light beams having different wavelengths and image projection apparatuses equipped with. such optical multiplexers, further size reduction of the devices can be achieved.

### REFERENCE SIGNS LIST

10 optical multiplexer

12 controller

15a R laser driver

15b G laser driver

15c B laser driver

16a R-LD

16b G-LD

16c B-LD

21 lens

22 scanner

23 scan driver

24 relay optical system

25 screen

101 first waveguide

102 second waveguide

103 third waveguide

110 first multiplexer

120 second multiplexer

1. An optical multiplexer that multiplexes a plurality of light beams, each light beam having a different wavelength, the optical multiplexer comprising:
a first waveguide that receives light of a first-wavelength;
a second waveguide that receives light of a second-wavelength, the second wavelength shorter than the first-wavelength;
a third waveguide that receives third-wavelength light having a shorter wavelength than the second-wavelength light;
a first multiplexer in which the light propagates between the first waveguide and the second waveguide; and
a second multiplexer in which the light propagates between the third waveguide and the first waveguide,
wherein the second-wavelength light is propagated to the first waveguide in the first multiplexer, and
wherein the third-wavelength light is propagated to the first waveguide in the second multiplexer.

2. The optical multiplexer of claim 1,
Wherein the first multiplexer has a length that is substantially half a length of the second multiplexer in a propagation direction.

2. The optical multiplexer of claim 2,
wherein the length of the first multiplexer is equal to twice a mode coupling length of the first-wavelength light.

4. The optical multiplexer of claim 1
wherein the first waveguide, the second waveguide, and the third waveguide are formed of a core layer and have a cladding layer disposed around the core layer and having a smaller refractive index than the core layer.

5. The optical multiplexer of claim 1,
wherein the plurality of light beams having the different wavelengths are visible light beams.

6. The optical multiplexer of claim 1,
wherein the first-wavelength light is propagated to the second waveguide in accordance with mode coupling in the first multiplexer,
wherein the first-wavelength light propagated to the second waveguide is propagated again to the first waveguide in the first multiplexer,
wherein the first-wavelength light propagated again to the first waveguide is propagated to the third waveguide in the second multiplexer, and
wherein the first-wavelength light propagated to the third waveguide is propagated again to the first waveguide in the second multiplexer.

7. The optical multiplexer of claim 1,
wherein the second-wavelength light is propagated to the first waveguide in accordance with mode coupling in the first multiplexer, and
wherein the second-wavelength light propagated to the first waveguide is propagated to the third waveguide in the second multiplexer and is subsequently propagated again to the first waveguide.

8. The optical multiplexer of claim 1,
wherein the third-wavelength light is propagated to the first waveguide in accordance with mode coupling in the second multiplexer.

9. An image projection apparatus equipped with the optical multiplexer of claim 1, the image projection apparatus comprising:
a first light source that outputs the first-wavelength light to the first waveguide;
a second light source that outputs the second-wavelength light to the second waveguide;
a third light source that outputs the third-wavelength light to the third waveguide; and
an image forming unit that two-dimensionally scans wavelength-multiplexed light output from the optical multiplexer to project an image onto a projection surface.

10. The optical multiplexer of claim 1, wherein:
the first waveguide does not have a bend, and
wherein the first waveguide is disposed between the second waveguide and the third waveguide.
